(19) United States
(12) Patent Application Publication
(10) Pub. No.: US 2025/0370100 A1
(43) Pub. Date: Dec. 4, 2025

(54) RADAR APPARATUS

(71) Applicant: HL Klemove Corp., Incheon (KR)

(72) Inventors: Han Byul LEE, Incheon (KR); Jung Hwan CHOI, Incheon (KR); Jingu LEE, Incheon (KR)

(73) Assignee: HL Klemove Corp., Incheon (KR)

(21) Appl. No.: 18/923,183

(22) Filed: Oct. 22, 2024

(30) Foreign Application Priority Data
Jun. 3, 2024 (KR) 10-2024-0072681

(51) Int. Cl. G01S 7/41; G01S 7/35; G01S 13/72; G01S 13/931

(52) U.S. Cl. CPC G01S 7/411; G01S 7/354; G01S 7/356; G01S 13/72; G01S 13/931

(57) ABSTRACT

The disclosure relates to a technology for identifying ghost targets using a radar apparatus. An antenna section includes a plurality of transmitting antennas and a plurality of receiving antennas. An extractor extracting a side lobe based on a virtual channel combination including M number of predetermined virtual channels, where M is a natural number equal to or greater than 2, and angle information of a target. A signal processor controls transmission and reception of a radar signal with respect to the target, and if the side lobe is extracted, determines that a ghost target is detected by the radar signal and processes the radar signal based on the determination.

### CROSS REFERENCE TO RELATED APPLICATION

This application claims priority from Korean Patent Application No. 10 10-2024-0072681, filed on Jun. 3, 2024, which is hereby incorporated by reference for all purposes as if fully set forth herein.

### BACKGROUND

### Field

Embodiments relate to a radar apparatus able to identify ghost targets.

### Description of Related Art

Recently, consumers have become increasingly concerned about the performance and safety of their vehicles. As demand for vehicle performance, driver comfort, and safety has increased, research and development of advanced driver assistance systems (ADAS) controlling a vehicle and assist a driver in driving the vehicle has continued. Such advanced driver assistance systems refer to systems that minimize or prevent damage from vehicle accidents by enabling drivers to take appropriate actions based on external environmental information detected by vehicle sensors and cameras, or by automatically controlling vehicles to create a safer driving environment.

In addition, automotive radar apparatuses are used in driver assistance systems or autonomous driving systems to measure the spacings, relative speeds, and heading angles of other vehicles and stationary targets by monitoring the environment. Specifically, a radar apparatus detects the azimuth of an object, i.e., the angle between the line of sight to the object in a horizontal plane and the forward direction of the vehicle, to determine whether driving is possible or whether the object actually exists. Accordingly, the radar apparatus may be configured with a structure in which a plurality of physically separate receiving antennas are arrayed for the radar sensor to have a high angular resolution characteristic. However, the target detected by the radar signal may be a ghost target that does not exist, depending on the antenna array spacing, the antenna array structure, or the angle information of the target, thereby causing a problem in vehicle operation.

### BRIEF SUMMARY

Embodiments may provide a radar apparatus able to identify ghost targets.

According to an aspect, embodiments provide a radar apparatus including: an antenna section including a plurality of transmitting antennas and a plurality of receiving antennas; an extractor extracting a side lobe based on a virtual channel combination including M number of predetermined virtual channels, where M is a natural number equal to or greater than 2, and angle information of a target; and a signal processor controlling transmission and reception of a radar signal with respect to the target, and if the side lobe is extracted, determining that a ghost target is detected by the radar signal and processing the radar signal based on the determination.

According to embodiments, the radar apparatus may identify ghost targets.

### DESCRIPTION OF DRAWINGS

The above and other objectives, features, and advantages of the present disclosure will be more clearly understood from the following detailed description, taken in conjunction with the accompanying drawings, in which:

FIG. 1 is a block diagram illustrating the configuration of a radar apparatus according to embodiments;

FIG. 2 is a block diagram schematically illustrating a process of determining a ghost target by the radar apparatus according to embodiments;

FIG. 3 is a diagram illustrating an implementation of the configuration of the radar apparatus according to embodiments;

FIG. 4 illustrates an arrangement of transmitting antennas and receiving antenna according to embodiments;

FIG. 5 illustrates separation distances of the transmitting antennas and the receiving antenna according to embodiments;

FIG. 6 illustrates virtual channels according to embodiments;

FIG. 7 illustrates an operation of creating an ULA from DCAs according to embodiments

FIG. 8 illustrates a beam pattern of an angle power spectrum for the radar apparatus having a ULA structure according to embodiments;

FIG. 9 illustrates another beam pattern of an angle power spectrum for the radar apparatus having a ULA structure according to embodiments;

FIG. 10 illustrates another beam pattern of an angle power spectrum for the radar apparatus having an NLA or SLA structure according to embodiments; and

FIG. 11 illustrates another beam pattern of an angle power spectrum for the radar apparatus having an NLA or SLA structure according to embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

As used herein, the terms “transmitting antenna” and “receiving antenna” refer to antennas radiating radar signals and receiving reflection radar signals reflected by objects. For example, each of the antennas may be an antenna including one or more patch antennas. Otherwise, the antenna may be a micro-strip patch antenna. Otherwise, the antenna may be a waveguide antenna. However, the antenna according to the present disclosure may be configured in various manners as an antenna capable of radiating radar signals and receiving reflected radar signals without being limited in type.

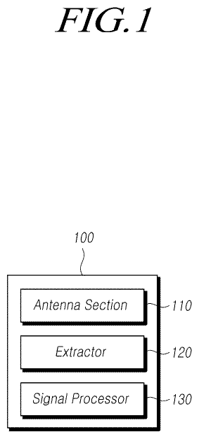

FIG. 1 is a block diagram illustrating the configuration of a radar apparatus according to embodiments.

Referring to FIG. 1, the radar apparatus 100 of the present disclosure includes an antenna section 110 including a plurality of transmitting antennas and a plurality of receiving antennas.

An antenna may refer to an apparatus that converts an electrical signal represented by a voltage/current into an electromagnetic wave represented by an electric/magnetic field and vice versa. The antenna may transmit a beam or radar signal having a specific direction, size, and shape to detect a target and obtain information about the target.

The antenna may also perform beamforming which focuses radiated energy in a specific direction in space. The purpose of beamforming is to receive a stronger signal in a desired direction or to deliver a signal having more concentrated energy in a desired direction.

In addition, the number and type of the transmitting antennas and receiving antennas included in the antenna section are not limited. The plurality of transmitting antennas may transmit radar signals to the target through transmitting channels and receive reflected signals from the target through receiving channels. However, a radar signal may be transmitted and received for a target that does not actually exist due to at least one factor of the arrangement states of the antennas, the spacings between the antennas, the elevation angle of the target, or the azimuthal angle of the target. Herein, such a target may be referred to as a ghost target. The present disclosure proposes a method of determining whether a target detected by a radar signal is a ghost target based on a side lobe extracted for processing a radar signal transmitted and received to and from the ghost target.

In an example, the plurality of transmitting antennas of the present disclosure may be spaced apart from each other based on a predetermined separation distance of the transmitting antennas. For example, when there are four transmitting antennas, the distance from the first transmitting antenna to the second transmitting antenna may be referred to as the first transmitting separation distance, the distance from the second transmitting antenna to the third transmitting antenna may be referred to as the second transmitting separation distance, and the distance from the third transmitting antenna to the fourth transmitting antenna may be referred to as the third transmitting separation distance. The first transmitting separation distance, the second transmitting separation distance, and the third transmitting separation distance described above may be all the same, all different, or only partially the same.

In another example, the plurality of receiving antennas of the present disclosure may be spaced apart from each other based on a predetermined separation distance of the receiving antennas. For example, if there are four receiving antennas, the distance from the first receiving antenna to the second receiving antenna may be referred to as the first receiving separation distance, the distance from the second receiving antenna to the third receiving antenna may be referred to as the second receiving separation distance, and the distance from the third receiving antenna to the fourth receiving antenna may be referred to as the third receiving separation distance. The first receiving separation distance, the second receiving separation distance, and the third receiving separation distance described above may be all the same, all different, or only partially the same.

Each of the separation distances between the respective transmitting antennas and between the respective receiving antennas may be set based on a predetermined unit separation distance. The unit separation distance may be set to the half-wavelength 0.5λ of the frequency of a radar signal transmitted by a transmitting antenna. However, this is illustrative only, and the unit separation distance may be set to ¼ wavelength (λ), ¾ wavelength (λ), or the like, as desired.

In another example, the plurality of transmitting antennas and the plurality of receiving antennas may be arranged on respective straight lines to be spaced apart from each other. For example, the plurality of transmitting antennas may be spaced apart from each other on a single straight line. In addition, the plurality of receiving antennas may be spaced apart from each other on another single straight line. Otherwise, the plurality of transmitting antennas and the plurality of receiving antennas may be arranged such that the straight line on which the plurality of transmitting antennas are spaced apart is parallel to the straight line on which the plurality of receiving antennas are spaced apart. Otherwise, the plurality of transmitting antennas and the plurality of receiving antennas may be arranged on a single straight line to be spaced apart from each other.

In another example, the plurality of transmitting antennas of the present disclosure may be arranged in a region above (or over) or below (or under) the plurality of receiving antennas in a vertical direction. That is, all of the plurality of transmitting antennas of the present disclosure may be arranged in the region above (or over) the plurality of receiving antennas, or all of the plurality of transmitting antennas may be disposed in the region or below (or under) the plurality of receiving antennas.

In another example, the antenna section 110 may include four transmitting antennas and four receiving antennas, each antenna having a sparse linear arrangement (SLA) structure.

Antenna arrangement methods may include a non-uniform linear arrangement (NLA) method or a sparse linear arrangement (SLA) method, in which a plurality of antennas are spaced apart by various predetermined spacings and a uniform linear arrangement (ULA) method, in which a plurality of antennas are spaced apart by a constant spacing.

Specifically, the NLA antenna arrangement or the SLA antenna arrangement may be a method in which N number of antennas (where N is an integer equal to or greater than 2) are spaced apart from each other by various distances, while the ULA antenna arrangement may be a method in which N number of antennas are spaced apart from each other at the same distance.

The present disclosure proposes a method able to identify a ghost target and process the corresponding laser signal in a radar apparatus including antennas having an NLA or SLA structure as well as an ULA structure in which a separation distance between antennas is constant.

The radar apparatus 100 of the present disclosure includes an extractor 120 extracting a side lobe based on a combination of virtual channels (hereinafter, referred to as a “virtual channel combination”) including M number of predetermined virtual channels (where M is a natural number equal to or greater than 2) and the angle information of the target.

For example, in a radar apparatus having two transmitting antennas and two receiving antennas as antenna sections, four virtual channels may be created, in which first virtual channels are based on first transmitting antennas and first receiving antennas, second virtual channels are based on the first transmitting antenna and the second receiving antenna, third virtual channels are based on the second transmitting antenna and the first receiving antenna, and fourth virtual channels are based on the second transmitting antenna and the second receiving antenna. Thus, the virtual channel combination may be a combination of a total of six virtual channels {{first virtual channel, second virtual channel}, {first virtual channel, third virtual channel}, {first virtual channel, fourth virtual channel}, {first virtual channel, third virtual channel}, {first virtual channel, fourth virtual channel}, {first virtual channel, second virtual channel, third virtual channel}, {first virtual channel, fourth virtual channel}, {first virtual channel, second virtual channel, third virtual channel, fourth virtual channel}. In another example, in the case of a combination of three virtual channels, a combination of a total of four virtual channels {{1 virtual channel, 2 virtual channel, 3 virtual channel}, {1 virtual channel, 2 virtual channel, 4 virtual channel}, {1 virtual channel, 3 virtual channel, 4 virtual channel}, {2 virtual channel, 3 virtual channel, 4 virtual channel}, {2 virtual channel, 3 virtual channel, 4 virtual channel}} may be provided.

Therefore, the radar apparatus 100 of the present disclosure may set various virtual channel combinations depending on the number of virtual channels. In addition, by extracting the side lobe based on the virtual channel combination of the radar apparatus 100 and the angle information of the target, it is possible to determine whether the target detected by the radar signal is a ghost target.

In an example, the side lobe may be stored in a look-up table (LUT) in a manner corresponding to at least one of angle information, a virtual channel combination, or a difference co-arrangement (DCA) combination.

The radar apparatus 100 of the present disclosure may store whether the side lobe exists, i.e., whether the side lobe exists based on a virtual channel combination, predetermined angle information of a target, a virtual channel combination, and a DCA combination, in a predetermined table. Accordingly, whether the side lobe exists may be determined using the table in which the virtual channel combination and the angle information of the target or the DCA combination and the angle information of the target transmitted by the radar apparatus 100 are stored.

For example, the table may include information about whether the side lobe exists corresponding to the angle information and the virtual channel combination, and the information about whether the side lobe exists corresponding to the angle information and the DCA combination.

In an example, the radar apparatus 100 of the present disclosure may be configured as one virtual channel combination selected from {{first virtual channel, second virtual channel}, {first virtual channel, third virtual channel}, {first virtual channel, fourth virtual channel}, {second virtual channel, third virtual channel}, {second virtual channel, fourth virtual channel}, {third virtual channel, fourth virtual channel} or {first virtual channel, second virtual channel, third virtual channel}, {first virtual channel, second virtual channel, fourth virtual channel}, {first virtual channel, third virtual channel, fourth virtual channel}, {second virtual channel, third virtual channel, fourth virtual channel}}.

In another example, the radar apparatus 100 of the present disclosure may be configured as one DCA combination selected from {{first DCA, second DCA}, {first DCA, third DCA}, {first DCA, fourth DCA}, {second DCA, third DCA}, {second DCA, fourth DCA}, {third DCA, fourth DCA}} or {{first DCA, second DCA, third DCA}, {first DCA, second DCA, fourth DCA}, {first DCA, third DCA, fourth DCA}, {second DCA, third DCA, fourth DCA}}.

The virtual channel combinations and the DCA combinations described above may be set based on a predetermined number, and the radar apparatus 100 of the present disclosure may transmit and receive radar signals to a target based on any of various virtual channel and DCA combinations.

The virtual channel combination and the DCA combination are not limited to the above, and may be set variously depending on the number and type of virtual channels and DCAs created and the number of virtual channels or DCAs to be combined.

In another example, the extractor 120 may retrieve, from the table, a side lobe corresponding to the virtual channel combination and the angle information of the target or the DCA combination and the angle information of the target.

If the side lobe is extracted, the radar apparatus 100 of the present disclosure may determine that a ghost target is detected by the radar signal. However, extracting the side lobe is not intended to be limiting, and detecting a ghost target may also be determined by determining the change in the side lobe. Otherwise, whether the ghost target is detected by the radar signal may be determined by evaluating the presence or location of the side lobe using a trained artificial intelligence model.

In another example, the angle information described above may be characterized by including at least one of an azimuth angle or an elevation angle.

The radar apparatus 100 of the present disclosure may measure the azimuth angle or the elevation angle of the target using signals received from the target, for example, a fast Fourier transform (FFT) result or a beam vector for each array element, such as a steering vector reflecting the position of the array element.

In another example, the virtual channel combination described above may be one of virtual channel combinations, in which M number of predetermined virtual channels is randomly extracted from a plurality of virtual channels (where M is a natural number equal to or greater than 2).

In another example, the plurality of virtual channels described above may be created based on at least one of the predetermined separation distance of the transmitting antennas or the predetermined separation distance of the receiving antennas.

In another example, the number of the plurality of virtual channels described above may be determined based on the number of the plurality of transmitting antennas and the number of the plurality of receiving antennas.

The radar apparatus 100 of the present disclosure may create virtual channels based on the transmitting antennas and the receiving antennas, wherein the number of the virtual channels may be determined based on the number of the transmitting antennas and the number of the receiving antennas, and the spacing between the virtual channels may be determined based on the separation distance of the transmitting antennas and the separation distance of the receiving antennas. For example, if the antenna section includes four transmitting antennas and four receiving antennas, the number of virtual channels may be 16, which is the product of the number of the transmitting antennas and the number of the receiving antennas.

In another example, the extractor 120 may extract the side lobe based on the angle information and DCA combination.

In another example, the DCA combination described above may be one of DCA combinations, in which K number of DCAs are randomly extracted from a plurality of DCAs (where K is a natural number equal to or greater than 2).

The radar apparatus 100 of the present disclosure includes a signal processor 130 controlling the transmission and reception of a radar signal with respect to a target, if a side lobe is extracted, determining that a ghost target is detected by the radar signal, and processing the radar signal based on the determination.

In an example, the signal processor 130 may process the radar signal by creating a plurality of DCAs based on the plurality of virtual channels, removing one DCA having a non-uniform DCA spacing from the plurality of DCAs, and creating a uniform linear arrangement (ULA) from the remaining DCAs.

The radar apparatus of the present disclosure may measure the azimuth angle or the elevation angle of the target using a signal received from the target, such as an FFT result or a beam vector for each array element, such as a steering vector reflecting the position of the array element, determine whether a ghost target is detected by a radar signal depending the position change or the matching of the extracted side lobe based on at least one of the arrangement of the transmitting antennas and the receiving antennas, the spacings between the antennas, or the angle information of the target, thereby having the effect of increasing the target detection performance of the radar apparatus.

Hereinafter, the above-described antenna arrangement structure, side lobe, and the like will be described with reference drawings. However, this is for ease of understanding only, and it is evident that any arrangement structure not shown below may be realized by any combination of the various embodiments described above. Accordingly, any combination of the various embodiments described above should be included in embodiments of the present disclosure.

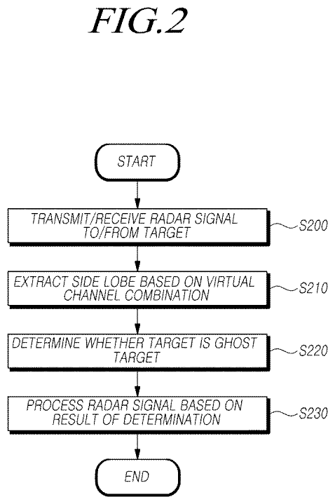

FIG. 2 is a block diagram schematically illustrating a process of determining a ghost target by the radar apparatus according to embodiments.

Referring to FIG. 2, the radar apparatus of the present disclosure may determine whether a target detected using a radar signal is a target that actually exists.

The radar apparatus of the present disclosure transmits radar signals to a target around the radar apparatus and receives reflected signals from the target in S200. Specifically, the radar apparatus of the present disclosure includes a plurality of transmitting antennas and a plurality of receiving antennas, and at least one antenna of the plurality of transmitting antennas transmits a radar signal to the target through a transmitting channel. Upon arrival of the radar signal at the target, the radar signal may be reflected and received by the antenna through the receiving channel of the radar apparatus.

The movement speed, position, angle information including the azimuth angle and the elevation angle, and the like of the target may be detected based on the round-trip time from the transmission to the reception, the speed, the direction information, and the like of the radar signal.

The radar apparatus of the present disclosure, upon receiving the radar signal reflected by the target to the radar apparatus, extracts the side lobe based on the virtual channel combination in S210.

Specifically, an antenna in which a plurality of antennas are arrayed according to a predetermined scheme is referred to as an array antenna. The largest radiation pattern of the radar signal transmitted by the array antenna is referred to as the main lobe, and smaller patterns occurring around the main lobe are referred to as side lobes. Whether the lobe is a main lobe or a side lobe may be determined based on information about the virtual channel combination and the angle information of the target or information about the DCA combination and the angle information of the target with respect to the radar signal transmitted by the radar apparatus.

The radar apparatus of the present disclosure may extract the side lobe based on the information about the virtual channel combination with respect to the radar signal transmitted and received to and from the target and the angle information of the target. Otherwise, the radar apparatus of the present disclosure may extract the side lobe based on the information about the DCA combination and the angle information of the target. The extraction of the side lobe indicates that the radar signal has been transmitted and received for a ghost target that does not exist.

The radar apparatus of the present disclosure determines whether the target detected by the radar signal is a ghost target based on whether the side lobe has been extracted in S220.

In an example, if the side lobe is extracted based on the information about the virtual channel combination and the angle information of the target, it may be determined that a ghost target is detected by the radar signal. If the side lobe is not extracted, it may be determined that an existing normal target is detected by the radar signal.

In another example, if the side lobe is extracted based on the information about the DCA combination and the angle information of the target, it may be determined that a ghost target is detected by the radar signal. If the side lobe is not extracted, it may be determined that an existing normal target is detected by the radar signal.

Once it is determined that whether the target is a ghost target, the radar apparatus of the present disclosure processes the radar signal based on the result of the determination in S230.

If it is determined that the target detected by the radar signal is a ghost target, the radar apparatus of the present disclosure does not consider the radar signal in determining information such as the position, the movement speed, and the like of the target.

In addition, if it is determined that the target detected by the radar signal is not a ghost target, the radar apparatus of the present disclosure may consider the radar signal in determining information about the target.

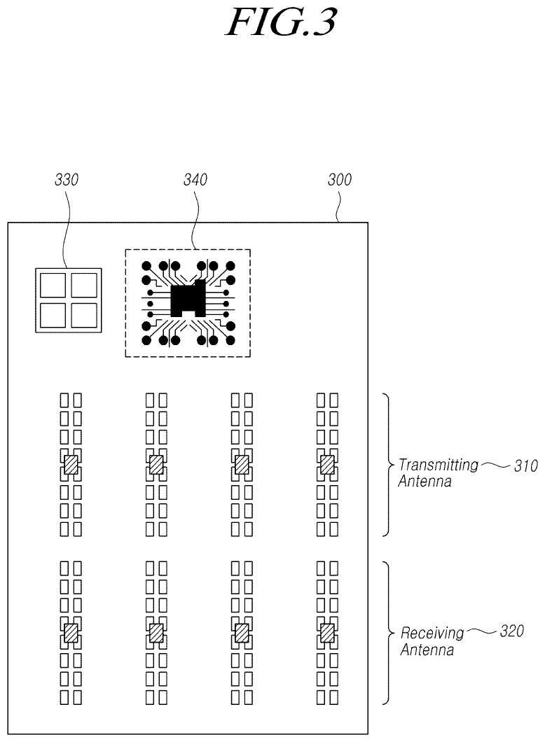

FIG. 3 is a diagram illustrating an implementation of the configuration of the radar apparatus according to embodiments.

The radar apparatus 300 may have a configuration including a plurality of transmitting antennas 310, a plurality of receiving antennas 320, a side lobe extractor 330, and a signal processor 340.

During target detection, an interference signal may be created depending on the beam pattern of the antenna, and must be removed as desired. This is known as the ambiguity problem caused by a side lobe or a grating lobe.

For example, a ghost target having no radar signal transmitted thereto may be detected due to, for example, the spacings or arrangement shapes of the plurality of transmitting antennas 310 and the plurality of receiving antennas 320.

Therefore, the present disclosure proposes to process a radar signal by which a ghost target is detected by extracting a side lobe based on the virtual channel combination, the DCA combination, or the angle information of the target in order to reduce the ambiguity described above.

Specifically, the radar apparatus 300 of the present disclosure may include the side lobe extractor 330 extracting side lobes based on virtual channel combinations for the plurality of transmitting antennas 310 and the plurality of receiving antennas 320 and angle information of a target or DCA combinations and the angle information of the target.

As described above, the side lobe may be extracted based on whether information is retrieved from a table containing virtual channel combinations created based on the transmitting antennas and the receiving antennas and angle information of the target or a table containing DCA combinations and the angle information of the target.

In addition, the radar apparatus 300 of the present disclosure may include the signal processor 340 controlling the transmission and reception of radar signals through the plurality of transmitting channels and the plurality of receiving channels and processing the radar signals.

The signal processor 340 of the present disclosure may include a monolithic microwave integrated circuit (MMIC). For example, the MMIC may refer to a single circuit in which active and passive elements are integrated. In addition, the MMIC may include a plurality of transmitting channels and a plurality of receiving channels. The plurality of transmitting channels may be connected to the plurality of transmitting antennas 310 of the present disclosure through respective power lines. The plurality of receiving channels may also be connected to the plurality of receiving antennas 320 of 41 present disclosure through respective power lines.

In an example, the signal processor 340 of the present disclosure may process signals transmitted by at least two of the plurality of transmitting antennas 310 to be transmitted simultaneously. This includes processing signals from the plurality of transmitting antennas to be transmitted simultaneously.

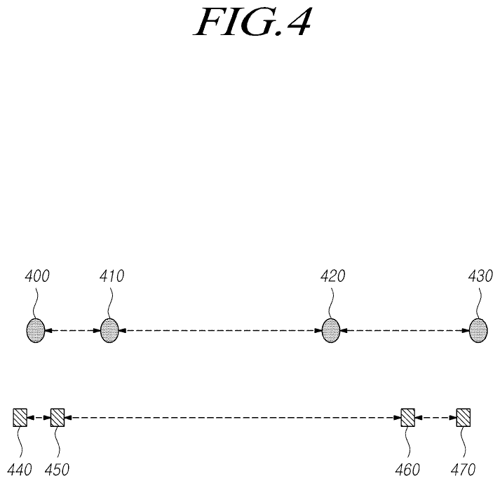

FIG. 4 illustrates an arrangement of the transmitting antennas and the receiving antenna according to embodiments.

Referring now to FIG. 4, the plurality of transmitting antennas and the plurality of receiving antennas of the present disclosure may be arranged on respective straight lines to be spaced apart from each other.

for ease of explanation, the present disclosure assumes that there are four transmitting antennas and four receiving antennas. Accordingly, the number of the transmitting antennas and the receiving antennas shown in FIG. 4 is illustrative only and may vary as desired.

Referring to FIG. 4, the transmitting antennas of the present disclosure may include four transmitting antennas, and the receiving antennas of the present disclosure may include four receiving antennas. In FIG. 4, the positions of the transmitting antennas are indicated by circles, and the positions of the receiving antennas are indicated by squares.

In the present disclosure, the four transmitting antennas may be referred to as a first transmitting antenna 400, a second transmitting antenna 410, a third transmitting antenna 420, and a fourth transmitting antenna 430, which may be spaced apart from each other by a set separation distance.

In the present disclosure, the four receiving antennas may be referred to as a first receiving antenna 440, a second receiving antenna 450, a third receiving antenna 460, and a fourth receiving antenna 470, which may be spaced apart from each other by a set separation distance.

In an example, the first transmitting antenna 400, the second transmitting antenna 410, the third transmitting antenna 420, and the fourth transmitting antenna 430 may be arranged on a straight line to be spaced apart from each other by a predetermined separation distance, and the first receiving antenna 440, the second receiving antenna 450, the third receiving antenna 460, and the fourth receiving antenna 470 may be arranged on a straight line different from the straight line, on which the four transmitting antennas are disposed, to be spaced apart from each other by a predetermined separation distance.

In another example, the straight line on which the first transmitting antenna 400, the second transmitting antenna 410, the third transmitting antenna 420, and the fourth transmitting antenna 430 are arranged may be parallel to the straight line on which the first receiving antenna 440, the second receiving antenna 450, the third receiving antenna 460, and the fourth receiving antenna 470 are arranged.

In another example, the first transmitting antenna 400, the second transmitting antenna 410, the third transmitting antenna 420, and the fourth transmitting antenna 430 may be arranged in a region above the straight line on which the first receiving antenna 440, the second receiving antenna 450, the third receiving antenna 460, and the fourth receiving antenna 470 are arranged.

In another example, the first transmitting antenna 400, the second transmitting antenna 410, the third transmitting antenna 420, and the fourth transmitting antenna 430 may be arranged in a region below the straight line on which the first receiving antenna 440, the second receiving antenna 450, the third receiving antenna 460, and the fourth receiving antenna 470 are arranged.

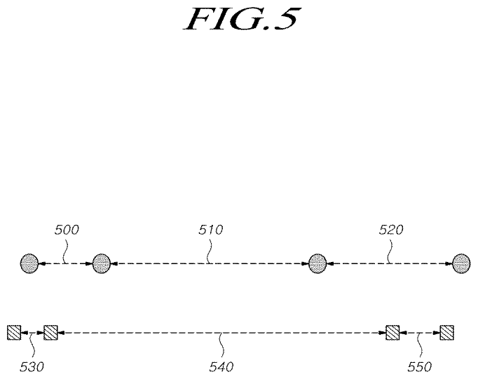

FIG. 5 illustrates separation distances of the transmitting antennas and the receiving antenna according to embodiments.

Referring to FIG. 5, a plurality of transmitting antennas and a plurality of receiving antennas may be spaced apart from each other by predetermined separation distances.

In an example, the separation distances according to the present disclosure may include a first separation distance 500 between the first transmitting antenna and the second transmitting antenna, a second separation distance 510 between the second transmitting antenna and the third transmitting antenna, a third separation distance 520 between the third transmitting antenna and the fourth transmitting antenna, a fourth separation distance 530 between the first receiving antenna and the second receiving antenna, a fifth separation distance 540 between the second receiving antenna and the third receiving antenna, and a sixth separation distance 550 between the third receiving antenna and the fourth receiving antenna.

In another example, at least one of the first separation distance 500, the second separation distance 510, the third separation distance 520, the fourth separation distance 530, the fifth separation distance 540, or the sixth separation distance 550 may be set based on a predetermined unit separation distance.

The unit separation distance may be set to a half wavelength 0.5λ of the frequency of the radar signal transmitted by the transmitting radars described above. However, this is illustrative only, and the unit separation distance may be variously set to a quarter wavelength 0.25λ, a three-quarter wavelength 0.75λ, or the like, as desired.

In another example, two or more of the first separation distance 500, the second separation distance 510, the third separation distance 520, the fourth separation distance 530, the fifth separation distance 540, and the sixth separation distance 550 may be set at a predetermined ratio. For example, the first separation distance 500, the third separation distance 520, the fourth separation distance 530, and the sixth separation distance 550 may be set at a ratio of 1:1:2:2.

The method of setting the respective separation distances is not limited to the above, but may be set variously as desired.

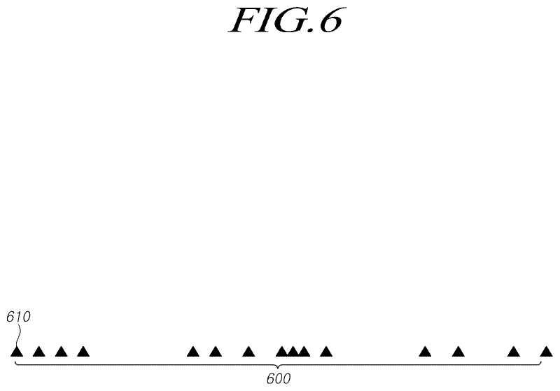

FIG. 6 illustrates virtual channels according to embodiments.

Referring to FIG. 6, a virtual channel 600 may be created based on separation distances of a plurality of transmitting antennas and a plurality of receiving antennas.

Triangles 610 in FIG. 6 represent individual virtual channels, respectively, created based on the separation distances of the transmitting antennas or the receiving antennas.

In an example, a total of 16 virtual channels 600 may be created for four transmitting antennas and four receiving antennas. In addition, the spacings between the respective virtual channels may be set based on the separation distances between the plurality of transmitting antennas and the plurality of receiving antennas.

In addition, if some of the generated virtual channels have the same position, the diagram may appear as if there are 15 channels even if 16 virtual channels 600 are generated, as shown in FIG. 6. The principle of creating virtual channels is disclosed in the known art “MIMO Radar (Rev. A) (ti.com)”, and a detailed description will be omitted.

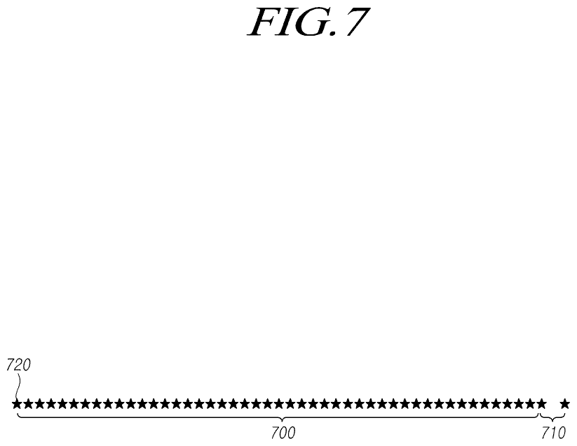

FIG. 7 illustrates creation of DCAs according to embodiments.

Referring to FIG. 7, the radar apparatus of the present disclosure may create difference co-arrangements (DCAs) 700 using created virtual channels.

An asterisk 710 in FIG. 7 indicates a single DCA created based on a virtual channel.

In an example, assuming that the radar apparatus of the present disclosure includes four transmitting antennas and four receiving antennas, the radar apparatus of the present disclosure may process radar signals by creating 16 virtual channels based on the separation distances of the transmitting antennas and the separation distances of the receiving antennas and creating 48 DCAs using the 16 virtual channels.

In another example, the radar apparatus of the present disclosure may process radar signals by removing the DCA 710 having a non-uniform DCA spacing from 48 DCAs and creating a uniform linear arrangement (ULA) from the 47 DCAs 700.

Ignoring the rightmost channel in the DCAs results in a contiguous array having a length of 46 and a uniform spacing of 1 for all. It is necessary to ignore the rightmost channel because if the rightmost channel is not ignored, the shape of the beam pattern will be unfavorable to the performance of the radar apparatus due to the empty space.

The principle of creating DCAs using virtual channels is disclosed in “C.-L. Liu and P. P. Vaidyanathan, ‘Robustness of Difference Coarrangements of Sparse Arrangements to Sensor Failures—Part I: A Theory Motivated by Coarrangement MUSIC,’ in IEEE Transactions on Signal Processing, vol. 67, no. 12, pp. 3213-3226, 15 Jun. 15, 2019, doi: 10.1109/TSP.2019.2912882”.

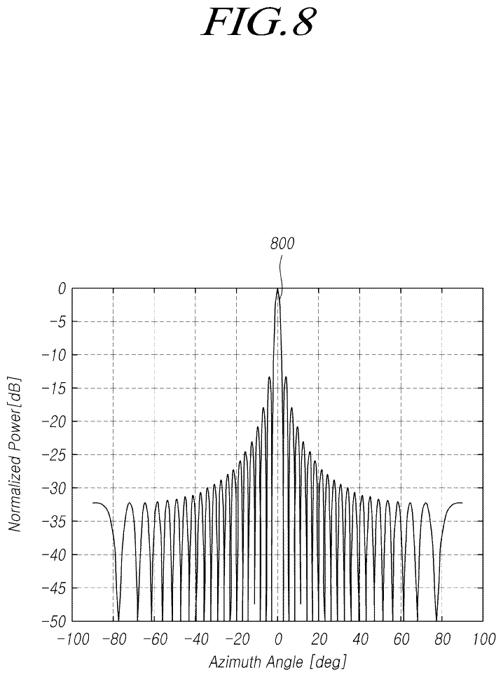

FIG. 8 illustrates a beam pattern of an angle power spectrum for the radar apparatus having a ULA structure according to embodiments.

Referring to FIG. 8, the angle power spectrum for the radar apparatus having a ULA structure may be seen if a unit separation distance is set to be the half wavelength 0.5λ.

For example, the radar apparatus having a ULA structure may be used to generate radar signals having an ideal beam pattern for the radar apparatus having a ULA structure based on the beam pattern having an angle power spectrum. This may be seen that the angle power spectrum has a single main lobe 800. Information about the respective lobes identified from the angle power spectrum as described above may be organized and stored in a table.

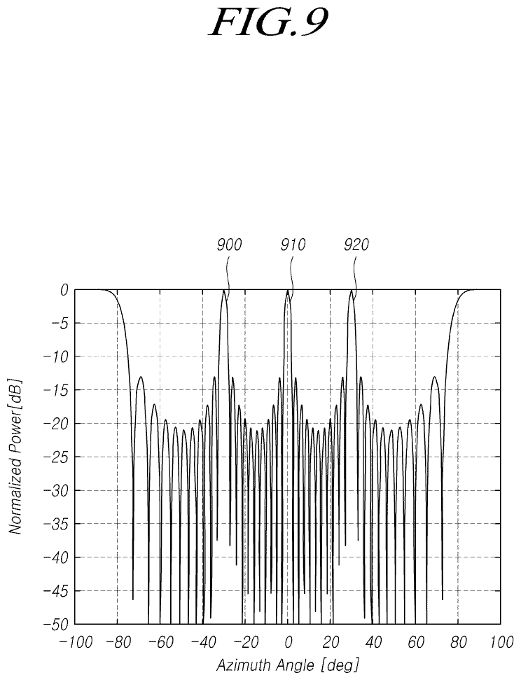

FIG. 9 illustrates another beam pattern of an angle power spectrum for the radar apparatus having a ULA structure according to embodiments.

Referring to FIG. 9, the angle power spectrum for the radar apparatus having a ULA structure if a unit separation distance is set to be 2 wavelengths 2λ may be seen.

The difference between the graphs in FIG. 8 and FIG. 9 shows that side lobes may occur in addition to the main lobe depending on the spacing or the arrangement structure of the antennas arrayed.

Side lobes may also be extracted for radar signals transmitted and received by the radar apparatus having a ULA structure, in which the unit separation distance is set to be two wavelengths 2λ. According to FIG. 9, a side lobe 900 on the left side and a side lobe 920 on the right side with respect to the main lobe 910 may be extracted. Accordingly, if the two wavelengths 2λ are set as the unit separation distance, the radar signals transmitted and received by the radar apparatus having a ULA structure may detect a ghost target according to the angle information of the target.

For example, if the radar apparatus of the present disclosure e has four transmitting antennas and four receiving antennas, 16 virtual channels may be created, and assuming that a radar signal is transmitted to a target through a virtual channel combination {first virtual channel, second virtual channel} and is reflected and received, the azimuth angle or the elevation angle of the target may be measured based on the transmitted/received radar signal.

The radar apparatus of the present disclosure may extract whether side lobe exists based on the virtual channel combination {first virtual channel, second virtual channel} and the azimuth angle or the elevation angle of the target. If the side lobe is extracted, the radar apparatus may determine that a ghost target is detected by the radar signal and process the radar signal. The radar apparatus of the present disclosure may also extract information about the side lobe by referring to a table stored for the side lobe corresponding to the virtual channel combination and the angle information of the target.

In another example, if the radar apparatus of the present disclosure has four transmitting antennas and four receiving antennas, 46 to 48 DCAs may be created, and assuming that a radar signal is transmitted to a target through the virtual channel combination {first DCA, second DCA} and is reflected and received, the azimuth angle or the elevation angle of the target may be measured based on the transmitted/received radar signal.

The radar apparatus of the present disclosure may extract whether a side lobe exists based on a DCA combination {first DCA, second DCA} and the azimuth angle or the elevation angle of the target. If the side lobe is extracted, the radar apparatus may determine that a ghost target is detected and process the corresponding radar signal. Similarly, the radar apparatus of the present disclosure may extract information about the side lobe by referring to a table stored for the side lobe corresponding to the DCA combination and the angle information of the target.

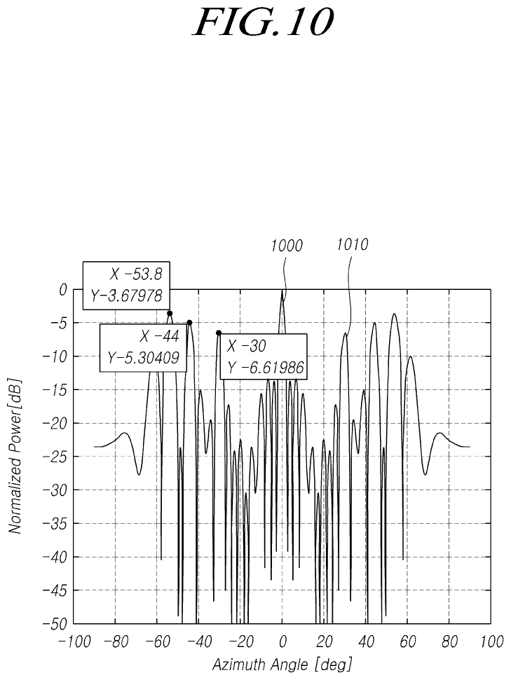

FIG. 10 illustrates another beam pattern of an angle power spectrum for the radar apparatus according to embodiments.

Referring to FIG. 10, the angle power spectrum for the radar apparatus having an NLA or SLA structure in which a unit separation distance is set to the range of a half wavelength 0.5λ to two wavelengths 2λ may be seen.

Side lobes may be extracted even for the radar apparatus in which the unit separation distance is not constant and the spacing between antennas is set variously. Referring to FIG. 10, a plurality of side lobes in addition to a side lobe 1010 on the right side with respect to the main lobe 1000 may be extracted. In addition, a plurality of side lobes may be extracted from the left with respect to the main lobe 1000.

As illustrated in FIG. 9 by way of example, the radar apparatus of the present disclosure may extract whether a side lobe exists based on the virtual channel combination {first virtual channel, second virtual channel} and the azimuth angle or the elevation angle of the target. If the side lobe is extracted, the radar apparatus may determine that a ghost target is detected and process the corresponding radar signal. The radar apparatus of the present disclosure may also extract information about the side lobe by referring to a table stored for the side lobe corresponding to the virtual channel combination and the angle information of the target.

In another example, if the radar apparatus of the present disclosure has four transmitting antennas and four receiving antennas, 46 to 48 DCAs may be generated, and assuming that a radar signal is transmitted to a target through the virtual channel combination {first DCA, second DCA} and is reflected and received, the azimuth angle or the elevation angle of the target may be measured based on the transmitted/received radar signal.

The radar apparatus of the present disclosure may extract whether a side lobe exists based on the DCA combination {first DCA, second DCA} and the azimuth angle or the elevation angle of the target. If the side lobe is extracted, the radar apparatus may determine that a ghost target is detected and process the corresponding radar signal. Similarly, the radar apparatus of the present disclosure may extract information about the side lobe by referring to a table stored for the side lobe corresponding to the DCA combination and the angle information of the target.

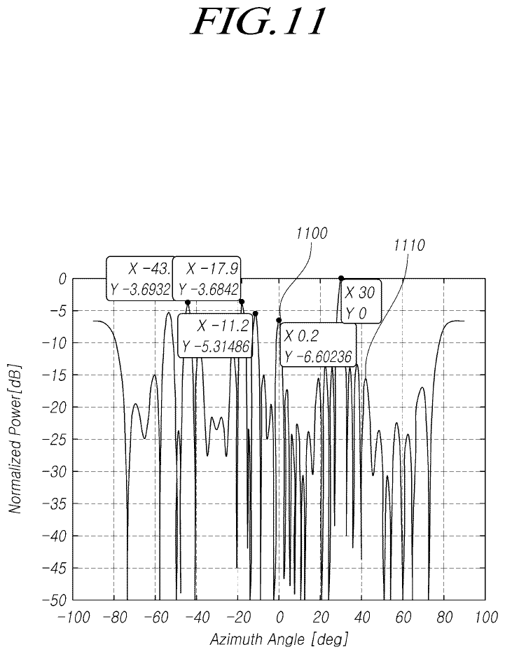

FIG. 11 illustrates another beam pattern of an angle power spectrum for the radar apparatus according to embodiments.

Referring to FIG. 11, the angle power spectrum for the radar apparatus having an NLA or SLA structure in which a unit separation distance is set to the range of a half wavelength 0.5λ to two wavelengths 2λ may be seen. The difference between the graphs in FIG. 10 and FIG. 11 shows that even for radar apparatuses having the same antenna array structure, the relative positions of the main-lobe and side lobes may differ depending on the angle of the target.

Side lobes may also be extracted even for the radar apparatus in which the unit separation distance is not constant and the spacing between antennas is set variously. Referring to FIG. 11, a plurality of side lobes in addition to a side lobe 1110 on the right side with respect to the main lobe 1100 may be extracted. In addition, a plurality of side lobes may be extracted from the left with respect to the main lobe 1100.

What is claimed is:

1. A radar apparatus comprising:
an antenna section comprising a plurality of transmitting antennas and a plurality of receiving antennas;
an extractor extracting a side lobe based on a virtual channel combination comprising M number of predetermined virtual channels, where M is a natural number equal to or greater than 2, and angle information of a target; and
a signal processor controlling transmission and reception of a radar signal with respect to the target, if the side lobe is extracted, determining that a ghost target is detected by the radar signal, and processing the radar signal based on the determination.

2. The radar apparatus of claim 1, wherein the plurality of transmitting antennas are arranged to be spaced apart from each other by a predetermined separation distance of the transmitting antennas, and
the plurality of receiving antennas are arranged to be spaced apart from each other by a predetermined separation distance of the receiving antennas.

3. The radar apparatus of claim 2, wherein the predetermined separation distance of the transmitting antennas and the predetermined separation distance of the receiving antennas are set based on a unit separation distance, and
the unit separation distance is set to be a half wavelength of a frequency of the radar signal transmitted by the transmitting antennas.

4. The radar apparatus of claim 1, wherein the plurality of transmitting antennas and the plurality of receiving antennas are arranged on respective straight lines to be spaced apart from each other.

5. The radar apparatus of claim 1, wherein the antenna section comprises four transmitting antennas and four receiving antennas, and has a sparse linear arrangement (SLA) structure.

6. The radar apparatus of claim 1, wherein the side lobe is stored in a look-up table (LUT) in a manner corresponding to at least one of the angle information, the virtual channel combination, or a difference co-arrangement (DCA) combination.

7. The radar apparatus of claim 6, wherein the extractor retrieves, from the table, the side lobe stored in a manner corresponding to at least one of the virtual channel combination, the angle information of the target, or the DCA combination.

8. The radar apparatus of claim 1, wherein the angle information comprises at least one of an azimuth angle or an elevation angle.

9. The radar apparatus of claim 1, wherein the angle information is determined based on the radar signal received by being reflected by the target and a fast Fourier transform (FFT) algorithm.

10. The radar apparatus of claim 1, wherein the virtual channel combination is one of virtual channel combinations, in which the M number of virtual channels is randomly extracted from a plurality of virtual channels.

11. The radar apparatus of claim 10, wherein the plurality of virtual channels are created based on at least one of a predetermined separation distance of the transmitting antennas or a predetermined separation distance of the receiving antennas.

12. The radar apparatus of claim 10, wherein the number of the plurality of virtual channels is determined based on the number of the plurality of transmitting antennas and the number of the plurality of receiving antennas.

13. The radar apparatus of claim 1, wherein the extractor extracts the side lobe based on the angle information and a DCA combination.

14. The radar apparatus of claim 13, wherein the DCA combination is one of DCA combinations in which K number of DCAs are randomly extracted from a plurality of DCAs, wherein K is a natural number equal to or greater than 2.

15. The radar apparatus of claim 14, wherein the signal processor processes the radar signal by creating the plurality of DCAs based on the plurality of virtual channels, removing one DCA having a non-uniform DCA spacing from the plurality of DCAs, and creating a uniform linear arrangement (ULA) from the remaining DCAs.
